(19) United States
(12) Patent Application Publication
(10) Pub. No.: US 2012/0268363 A1
(43) Pub. Date: Oct. 25, 2012

(54) IMAGE PROCESSING APPARATUS, IMAGE PROCESSING SYSTEM, IMAGE PROCESSING METHOD, AND COMPUTER READABLE MEDIUM

(75) Inventors: Tetsuya KIMURA, Kanagawa (JP); Kengo SHINOZAKI, Kanagawa (JP); Shoji SAKAMOTO, Kanagawa (JP); Yasuyuki SAGUCHI, Kanagawa (JP); Hideki BABA, Kanagawa (JP)

(73) Assignee: FUJI XEROX CO., LTD., Tokyo (JP)

(21) Appl. No.: 13/289,340

(22) Filed: Nov. 4, 2011

(30) Foreign Application Priority Data
Apr. 19, 2011 (JP) 2011-093398

(51) Int. Cl. G06F 3/01

(52) U.S. Cl. 345/156

(57) ABSTRACT

An image processing apparatus includes an imaged image acquiring unit, an identifying unit, an acquiring unit, and a display control unit. The imaged image acquiring unit acquires an imaged image. The identifying unit identifies an object imaged in the imaged image. The acquiring unit acquires image information on the object stored in association with the object identified by the identifying unit. The display control unit displays at least part of an image area of an object image based on the image information on the object.

### CROSS-REFERENCE TO RELATED APPLICATIONS

This application is based on and claims priority under 35 USC 119 from Japanese Patent Application No. 2011-093398 filed Apr. 19, 2011.

### BACKGROUND

The present invention relates to an image processing apparatus, an image processing system, an image processing method, and a computer readable medium.

### SUMMARY

According to an aspect of the invention, there is provided an image processing apparatus including an imaged image acquiring unit, an identifying unit, an acquiring unit, and a display control unit. The imaged image acquiring unit acquires an imaged image. The identifying unit identifies an object imaged in the imaged image. The acquiring unit acquires image information on the object stored in association with the object identified by the identifying unit. The display control unit displays at least part of an image area of an object image based on the image information on the object.

### BRIEF DESCRIPTION OF THE DRAWINGS

An exemplary embodiment of the present invention will be described in detail based on the following figures, wherein:

FIGS. 1A and 1B are outline views illustrating an example of a portable information terminal according to an exemplary embodiment of the present invention;

FIGS. 2A, 2B, and 2C illustrate an example of an infrared camera adaptor to be mounted on a camera portion of the portable information terminal;

FIGS. 3A, 3B, and 3C are outline views illustrating an example of a case where the infrared camera adaptor is mounted on the portable information terminal;

FIG. 4 illustrates an example of an object;

FIG. 5 illustrates an example of encoded patterns formed on the surface of the object;

FIG. 6 is a functional block diagram of the portable information terminal;

FIG. 7 illustrates an example of an object data table;

FIG. 8 illustrates an example of an additional information table;

FIG. 9 is a flowchart illustrating a process performed by the portable information terminal;

FIG. 10 illustrates an example of a display image;

FIG. 11 illustrates an example of a display image; and

FIG. 12 illustrates an example of a display image.

### DETAILED DESCRIPTION

Hereinafter, an exemplary embodiment of the present invention will be described with reference to the drawings. In this exemplary embodiment, an example in which an image processing apparatus according to an exemplary embodiment is applied to a portable information terminal having an imaging function and a display function will be explained.

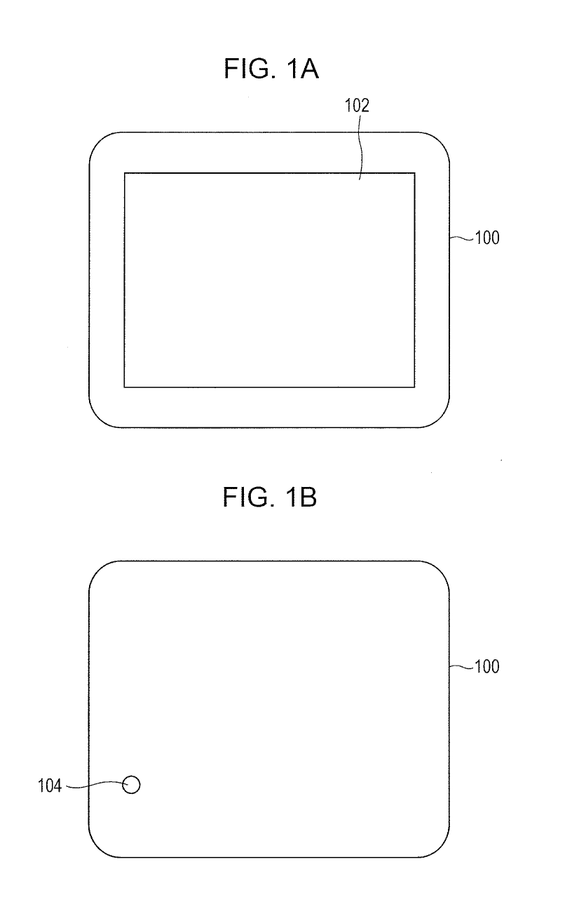

FIGS. 1A and 1B are outline views illustrating an example of a portable information terminal 100 according to this exemplary embodiment. FIG. 1A is a top view of the portable information terminal 100. FIG. 1B is a bottom view of the portable information terminal 100. As illustrated in FIGS. 1A and 1B, the portable information terminal 100 includes a touch panel 102 and a camera 104 provided on the bottom side of the touch panel 102.

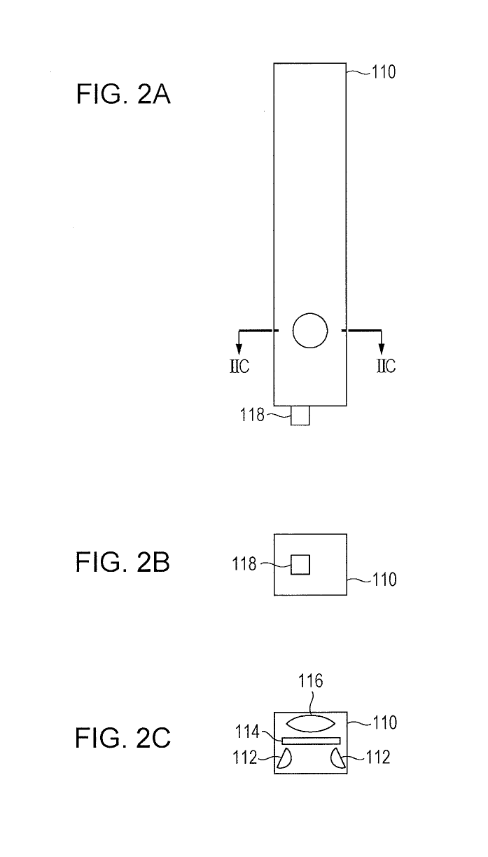

FIGS. 2A, 2B, and 2C illustrate an example of an infrared camera adaptor 110 to be mounted on the camera 104 of the portable information terminal 100. FIG. 2A is a top view of the infrared camera adaptor 110, FIG. 2B is a side view of the infrared camera adaptor 110, and FIG. 2C is a cross-sectional view of the infrared camera adaptor 110 taken along line IIC-IIC of FIG. 2A.

As illustrated in FIGS. 2A, 2B, and 2C, the infrared camera adaptor 110 includes an infrared light-emitting diode (LED) 112, a filter 114 that blocks light other than infrared light, and a close-up lens 116. The infrared camera adaptor 110 is mounted on the portable information terminal 100 in such a manner that the close-up lens 116 of the infrared camera adaptor 110 faces the camera 104 of the portable information terminal 100. The state of the infrared LED 112 is switched between a light-emitting state and a non-light-emitting state by a switch 118 provided on the infrared camera adaptor 110. In the case where the infrared LED 112 is in the light-emitting state, an LED provided in the switch 118 is controlled to emit light.

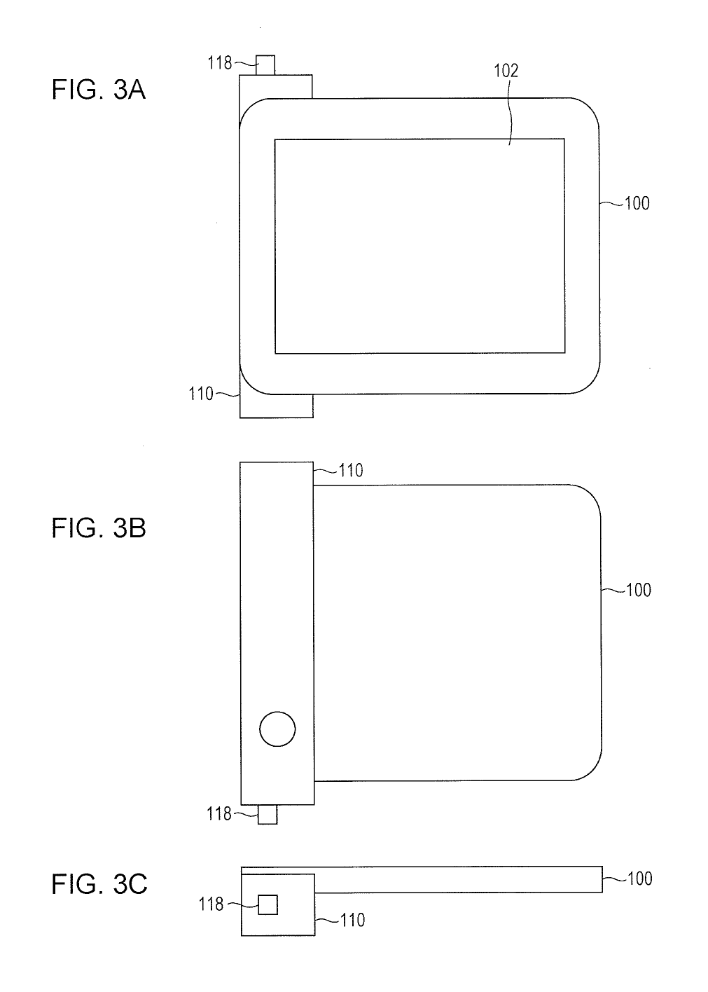

FIGS. 3A, 3B, and 3C are outline views illustrating an example of a case where the infrared camera adaptor 110 is mounted on the portable information terminal 100. FIGS. 3A, 3B, and 3C are top view, a bottom view, and a side view, respectively, of the portable information terminal 100 on which the infrared camera adaptor 110 is mounted.

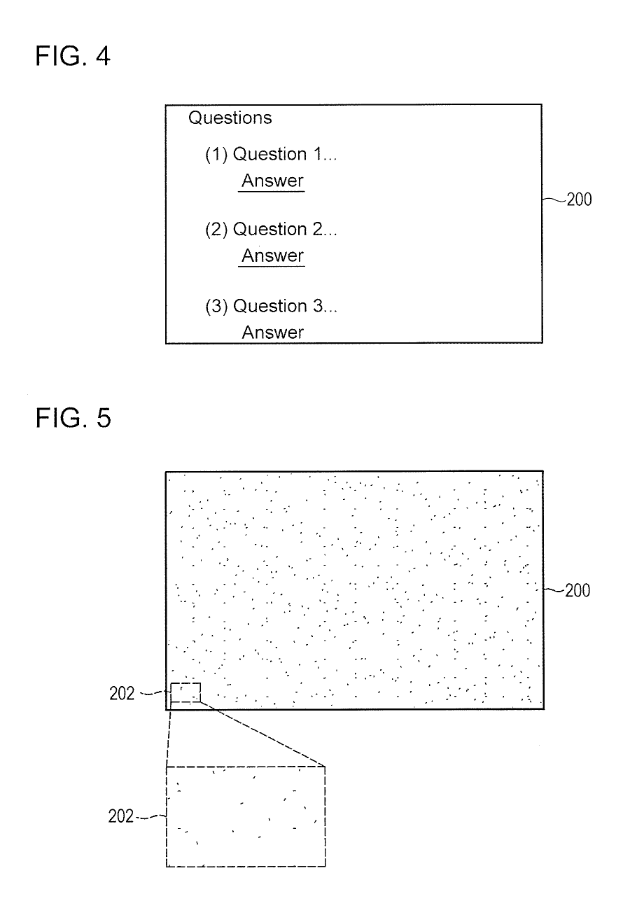

FIG. 4 illustrates an example of an object 200 to be imaged using the camera 104 provided in the portable information terminal 100. In this exemplary embodiment, the object 200 is a paper medium, and printing is performed on the surface of the object 200, as illustrated in FIG. 4.

Furthermore, encoded patterns 202 (dot codes) in which positional information corresponding to positions in the object 200 is encoded are formed, using an infrared absorbing material, on the object 200, as illustrated in FIG. 5.

FIG. 5 illustrates an example of the encoded patterns 202 formed on the surface of the object 200. As illustrated in FIG. 5, each of the encoded patterns 202 is a two-dimensional code composed of very small dots, and data is encoded by arranging plural dots formed for individual predetermined unit areas. A technique described, for example, in Japanese Unexamined Patent Application Publication No. 10-261059, may be employed for the encoded patterns 202. Data to be encoded into the encoded pattern 202 is not particularly limited as long as the data is information that identifies the object 200 and identifies a position in the object 200 (for example, identification information on the object 200 and positional information in the object 200).

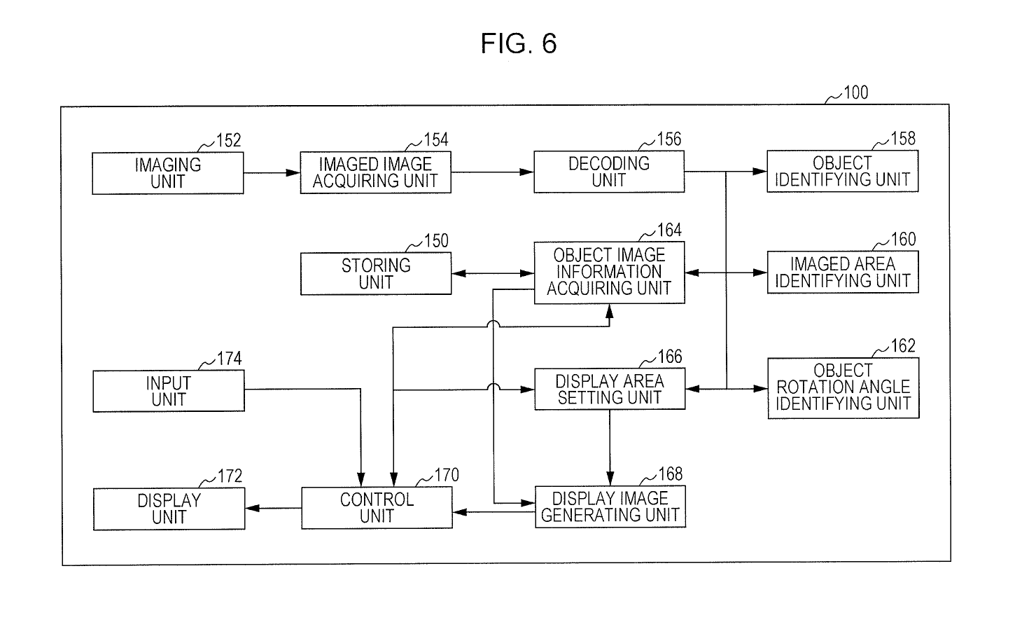

FIG. 6 is a functional block diagram of the portable information terminal 100 according to this exemplary embodiment. As illustrated in FIG. 6, the portable information terminal 100 includes a storing unit 150, an imaging unit 152, an imaged image acquiring unit 154, a decoding unit 156, an object identifying unit 158, an imaged area identifying unit 160, an object rotation angle identifying unit 162, an object image information acquiring unit 164, a display area setting unit 166, a display image generating unit 168, a control unit 170, a display unit 172, and an input unit 174.

Functions of the individual units provided in the portable information terminal 100 may be implemented when a computer including a control section such as a central processing unit (CPU), a storing section such as a memory, a communication section that transmits and receives data to and from an external device, an imaging section such as a camera, an input/display section such as the touch panel 102, etc. reads and executes a program that is stored in a computer-readable information storage medium. The program may be supplied to the portable information terminal 100, which is, for example, a computer, by an information storage medium such as an optical disk, a magnetic disk, a magnetic tape, a magneto-optical disk, or a flash memory or supplied via a data communication network such as the Internet.

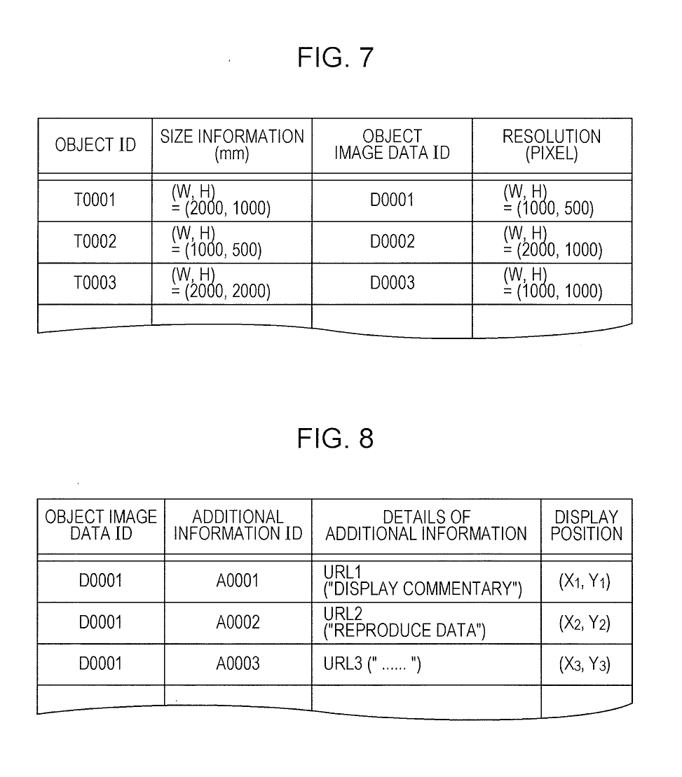

The storing unit 150 stores data and a program and is also used as a work memory. For example, an object data table illustrated in FIG. 7 is stored in the storing unit 150. As illustrated in FIG. 7, an object ID for identifying an object, size information on the size of the object (for example, longitudinal and lateral lengths etc.), an object image data ID for identifying image data of the object, and the resolution of the object image data (for example, the number of vertical and horizontal pixels etc.) are stored in the object data table. Furthermore, object image data is stored in the storing unit 150. The object image data may include additional information to be additionally displayed on an object image based on the object image data. The additional information is, for example, link information or annotation information. A display position in the object image is defined by the additional information.

FIG. 8 illustrates an example of an additional information table in which the correspondence between object image data and additional information is described. As illustrated in FIG. 8, an object image data ID, an additional information ID, the details of the additional information (for example, link information), and the position where the additional information is to be displayed (the display position in the object image) are stored in the additional information table. The correspondence described in the additional information table may be included in object image data or separately added to object image data. In the case where additional information displayed together with an object image is selected, processing is performed on the basis of the details of the additional information. For example, in the case where the additional information indicates a link, processing for accessing the link is performed. In the case where the additional information indicates the pass of execution data (audio data etc.), processing for reproducing the execution data indicated by the pass is performed.

The imaging unit 152 images an object using the camera 104 provided in the portable information terminal 100. For example, the imaging unit 152 may image, with the camera 104 of the portable information terminal 100 on which the infrared camera adaptor 110 is mounted, encoded patterns printed in infrared absorbing ink on the surface of an object.

The imaged image acquiring unit 154 acquires the image imaged by the imaging unit 152. For example, the imaged image acquiring unit 154 may acquire an imaged image obtained by imaging encoded patterns printed on the surface of the object.

The decoding unit 156 decodes the encoded patterns contained in the imaged image acquired by the imaged image acquiring unit 154. For example, the decoding unit 156 may sequentially extract unit areas each having a predetermined size from the imaged image, identify the arrangement of plural dots contained in the extracted unit area, and acquire data encoded into an encoded pattern on the basis of the identified arrangement. For example, the encoded data may include an object ID and positional information in the object.

The object identifying unit 158 identifies the object imaged in the imaged image acquired by the imaged image acquiring unit 154, on the basis of the result obtained by decoding the encoded pattern by the decoding unit 156. For example, in the case where the encoded pattern contains an object ID, the object identifying unit 158 may identify the object on the basis of the object ID contained in the encoded pattern. In the case where identification information on the object is contained in a predetermined area in the imaged image, scanning is performed on the predetermined area so that identification information on the object can be acquired.

The imaged area identifying unit 160 identifies an area of the object imaged in the imaged image acquired by the imaged image acquiring unit 154. For example, the imaged area identifying unit 160 may identify an area of the object imaged in the imaged image, on the basis of positional information in the object decoded by the decoding unit 156.

The object rotation angle identifying unit 162 identifies the rotation angle of the object imaged in the imaged image, on the basis of the imaged image acquired by the imaged image acquiring unit 154. The rotation angle around each of three axes (X-axis, Y-axis, and Z-axis) of the object may be defined as the rotation angle of the object. For example, the object rotation angle identifying unit 162 may compute the rotation angle of the object on the basis of the ratios of expansion and contraction in the vertical and horizontal directions of the encoded pattern contained in the imaged image and the rotation angle from the upright position of the encoded pattern.

The object image information acquiring unit 164 acquires image information on the object identified by the object identifying unit 158. For example, the object image information acquiring unit 164 may refer to the object image ID stored in the storing unit 150 in association with the object ID identified by the object identifying unit 158, and acquire the object image data stored in the storing unit 150, on the basis of the object image ID.

The display area setting unit 166 sets an area of the object image to be displayed (display area) based on the image information on the object acquired by the object image information acquiring unit 164. For example, the display area setting unit 166 may set, on the basis of the area of the object identified by the imaged area identifying unit 160, a display area corresponding to the area of the object. The display area setting unit 166 may set a display area that corresponds to the area of the object identified by the imaged area identifying unit 160 and corresponds to the area of the object corresponding to the size of the touch panel 102 of the portable information terminal 100.

The display image generating unit 168 generates a display image on the basis of the image information on the object acquired by the object image information acquiring unit 164, the display area set by the display area setting unit 166, and the rotation angle of the object identified by the object rotation angle identifying unit 162. For example, the display image generating unit 168 may generate a display image by extracting an image in the display area set by the display area setting unit 166 from the image information on the object acquired by the object image information acquiring unit 164 and performing image processing on the extracted image on the basis of the rotation angle of the object identified by the object rotation angle identifying unit 162.

The control unit 170 controls each unit of the portable information terminal 100. For example, the control unit 170 may control the display unit 172 to display the display image generated by the display image generating unit 168.

The display unit 172 is implemented by, for example, the touch panel 102, and displays an image under the control of the control unit 170. For example, the display unit 172 may display the display image generated by the display image generating unit 168.

The input unit 174 is implemented by, for example, the touch panel 102, and receives an operation instruction from a user.

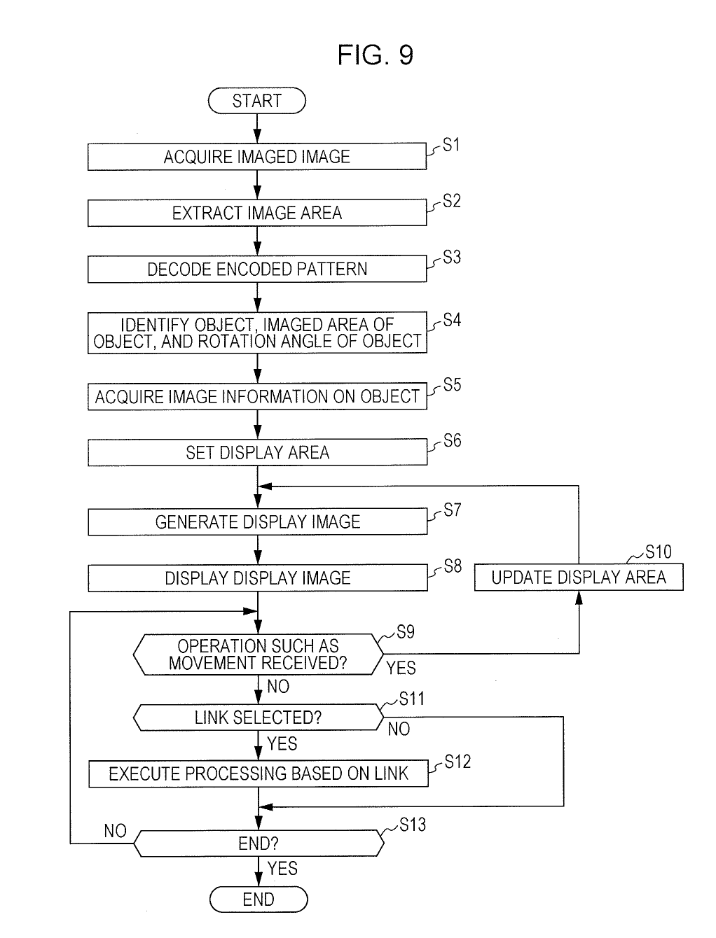

A process performed by the portable information terminal 100 will be explained by way of a specific example with reference to a flowchart illustrated in FIG. 9.

As illustrated in FIG. 9, the portable information terminal 100 acquires an imaged image obtained by imaging an object (step S1), and extracts from the acquired imaged image an image area where encoded patterns of the object are imaged (step S2).

The portable information terminal 100 decodes the encoded patterns contained in the image area extracted in step S2 (step S3), and identifies the object, the imaged area of the object, and the rotation angle of the object on the basis of the decoded data (step S4).

The portable information terminal 100 acquires image information on the object identified in step S4 (step S5), and sets a display area of the acquired image information on the object to be displayed (step S6). The portable information terminal 100 generates a display image on the basis of the image information on the object acquired in step S5, the display area set in step S6, and the rotation angle of the object identified in step S4 (step S7), and displays the generated display image (step S8).

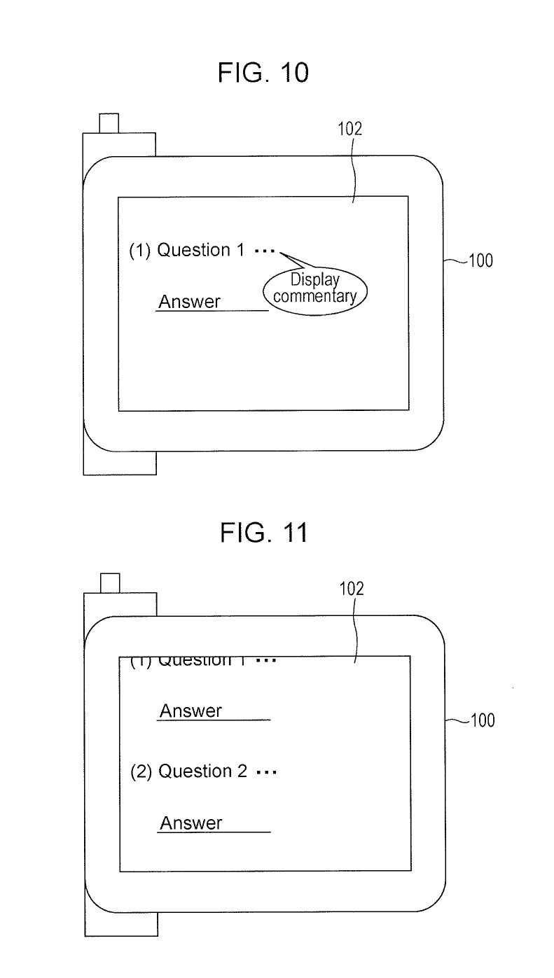

FIG. 10 illustrates an example of a display image displayed by the portable information terminal 100. The display image illustrated in FIG. 10 includes a part selected as a display area of an object image and additional information (link).

When receiving an instruction for an operation such as, for example, movement, expansion/contraction, or rotation of the image displayed on the touch panel 102 (YES in step S9), the portable information terminal 100 updates the display area on the basis of the received operation instruction (step S10). Then, the portable information terminal 100 generates a display image on the basis of the updated display area (step S7), and displays the generated display image (step S8).

FIG. 11 illustrates an example of a display image updated and displayed after an operation instruction for parallel displacement of the display image (for example, a drag operation) is received.

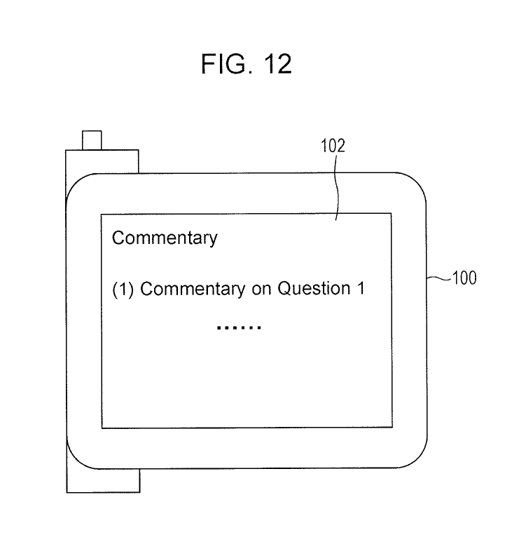

When the link in the display image is selected (YES in step S11), the portable information terminal 100 performs processing based on the link (step S12). FIG. 12 illustrates an example of a display image updated when the link is selected. In the example illustrated in FIG. 12, commentary information based on the link is displayed when the link is selected.

When the portable information terminal 100 determines that the process is not to be ended (NO in step S13), the process returns to step S9. When the portable information terminal 100 determines that the process is to be ended (YES in step S13), the process is ended.

The present invention is not limited to the exemplary embodiment described above. For example, in the portable information terminal 100, display based on an imaged image and display based on an object image may be selectively performed.

In the exemplary embodiment described above, an example in which an image processing apparatus according to an exemplary embodiment is applied to the portable information terminal 100 including an imaging section and a display section has been explained. However, the image processing apparatus may be applied to an apparatus not including an imaging section or a display section. Furthermore, in the exemplary embodiment described above, the infrared camera adaptor 110 is mounted on the camera of the portable information terminal 100 so that an infrared image can be acquired. However, an infrared camera may be provided instead of the camera 104.

In the exemplary embodiment described above, an example in which image information on an object is stored in the portable information terminal 100 has been explained. However, image information on an object may be stored in a server different from the portable information terminal 100, and in this case, the portable information terminal 100 may acquire the image information on the object from the server. Here, the server may perform processing from acquisition of an imaged image from the portable information terminal 100 to generation of a display image or only part of the processing.

In the exemplary embodiment described above, a display area set for an object image by the display area setting unit 166 is not limited to an area corresponding to the area of the object that is contained in the imaged image. The display area may be set on the basis of the distance between the object and the portable information terminal 100, the positional relationship between the portable information terminal 100 and a user, and the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
an imaged image acquiring unit that acquires an imaged image;
an identifying unit that identifies an object imaged in the imaged image;
an acquiring unit that acquires image information on the object stored in association with the object identified by the identifying unit; and
a display control unit that displays at least part of an image area of an object image based on the image information on the object.

2. The image processing apparatus according to claim 1, wherein:
the identifying unit further identifies an imaged part of the object in the imaged image; and
the display control unit displays the image area, which corresponds to the imaged part of the object in the object image.

3. The image processing apparatus according to claim 2, wherein:
an encoded pattern is formed on a surface of the object for each of a plurality of predetermined positions, the encoded pattern including encoded positional information indicating the corresponding position;
the imaged image acquiring unit acquires the imaged image, which is obtained by imaging the encoded pattern; and
the identifying unit identifies the imaged part of the object on the basis of the positional information obtained by decoding the encoded pattern contained in the imaged image.

4. The image processing apparatus according to claim 1, further comprising a unit that receives an operation instruction, wherein
the display control unit updates at least one of the size, position, and rotation angle of the image area on the basis of the received operation instruction, and displays the updated image area.

5. The image processing apparatus according to claim 2, further comprising a unit for receiving an operation instruction, wherein
the display control unit updates at least one of the size, position, and rotation angle of the image area on the basis of the received operation instruction, and displays the updated image area.

6. The image processing apparatus according to claim 3, further comprising a unit for receiving an operation instruction, wherein
the display control unit updates at least one of the size, position, and rotation angle of the image area on the basis of the received operation instruction, and displays the updated image area.

7. The image processing apparatus according to claim 1, wherein:
the image information on the object contains an image of the object and additional information defining a position in the image of the object and processing;
the display control unit displays additional information located in the image area; and
in a case where the additional information located in the image area displayed by the display control unit is selected, processing defined by the additional information is performed.

8. The image processing apparatus according to claim 2, wherein:
the image information on the object contains an image of the object and additional information defining a position in the image of the object and processing;
the display control unit displays additional information located in the image area; and
in a case where the additional information located in the image area displayed by the display control unit is selected, processing defined by the additional information is performed.

9. The image processing apparatus according to claim 3, wherein:
the image information on the object contains an image of the object and additional information defining a position in the image of the object and processing;
the display control unit displays additional information located in the image area; and
in a case where the additional information located in the image area displayed by the display control unit is selected, processing defined by the additional information is performed.

10. The image processing apparatus according to claim 4, wherein:
the image information on the object contains an image of the object and additional information defining a position in the image of the object and processing;
the display control unit displays additional information located in the image area; and
in a case where the additional information located in the image area displayed by the display control unit is selected, processing defined by the additional information is performed.

11. The image processing apparatus according to claim 5, wherein:
the image information on the object contains an image of the object and additional information defining a position in the image of the object and processing;
the display control unit displays additional information located in the image area; and
in a case where the additional information located in the image area displayed by the display control unit is selected, processing defined by the additional information is performed.

12. The image processing apparatus according to claim 6, wherein:
the image information on the object contains an image of the object and additional information defining a position in the image of the object and processing;
the display control unit displays additional information located in the image area; and
in a case where the additional information located in the image area displayed by the display control unit is selected, processing defined by the additional information is performed.

13. An image processing system comprising:
an imaging apparatus that images an object; and
an image processing apparatus, wherein
the image processing apparatus including
an imaged image acquiring unit that acquires an imaged image imaged by the imaging apparatus,
an identifying unit that identifies the object imaged in the imaged image,
an acquiring unit that acquires image information on the object stored in association with the object identified by the identifying unit, and
a display control unit that displays at least part of an image area of an object image based on the image information on the object.

14. An image processing method comprising:
acquiring an imaged image;
identifying an object imaged in the imaged image;
acquiring image information on the object stored in association with the identified object; and
displaying at least part of an image area of an object image based on the image information on the object.

15. A computer readable medium storing a program causing a computer to execute a process comprising:
acquiring an imaged image;
identifying an object imaged in the imaged image;
acquiring image information on the object stored in association with the identified object; and
displaying at least part of an image area of an object image based on the image information on the object.
